(19) United States
(12) Patent Application Publication
(10) Pub. No.: US 2014/0210262 A1
(43) Pub. Date: Jul. 31, 2014

(54) Vehicle Drive Device

(71) Applicants: Sho Yaegaki, Hitachinaka (JP); Hiroyuki Yamada, Hitachinaka (JP)

(72) Inventors: Sho Yaegaki, Hitachinaka (JP); Hiroyuki Yamada, Hitachinaka (JP)

(73) Assignee: Hitachi Automotive Systems, Ltd., Hitachinaka-shi (JP)

(21) Appl. No.: 14/239,079

(22) PCT Filed: Jul. 25, 2012
(86) PCT No.: PCT/JP2012/068850

§ 371 Date: Feb. 14, 2014

(30) Foreign Application Priority Data
Aug. 18, 2011 (JP) 2011-179025

(51) Int. Cl. B60L 11/12

(52) U.S. Cl. CPC B60L 11/12; Y10S 903/93
USPC 307/10.1; 903/930; 180/65.265

(57) ABSTRACT

A vehicle drive device includes an electric motor; a first electrical storage device that is of a high-voltage type and supplies an electric power to the electric motor; a plurality of auxiliary machines; a second electrical storage device that is of a low-voltage type and supplies an electric power to the plurality of auxiliary machines; and a vehicle control device. The first electrical storage device can supply an electric power to the second electrical storage device. The vehicle control device determines whether a degree of degradation of the first electrical storage device can be determined, selects a auxiliary machine from the plurality of auxiliary machines, and drives the selected auxiliary machine to estimate the degree of degradation of the first electrical storage device when it is judged that the degree of degradation of the first electrical storage device can be determined.

### TECHNICAL FIELD

The present invention relates to an electromotive drive device for a vehicle having an electric motor and an electrical storage device.

### BACKGROUND ART

In general, many electric motors are mounted, for instance, in a hybrid electric vehicle (HEV) and in an electric vehicle (EV). For vehicle drive purposes, in particular, a high-output electric motor is used. These electric motors are driven by AC power supplied from an inverter. The inverter receives DC power supplied from a battery or other DC power source and converts the DC power to AC power. The employed battery is formed of an assembled battery having a plurality of secondary battery cells such as nickel-hydrogen battery cells or lithium battery cells.

State of health (SOH) is a parameter indicative of degradation of such a battery or secondary battery cell. The SOH is calculated so that it represents an increase in the internal resistance of the battery or secondary battery cell from its initial value. In general, the internal resistance of each secondary battery cell is calculated. The degree of battery degradation is determined in accordance with the most seriously degraded secondary battery cell of all the secondary battery cells included in the battery.

The internal resistance R of the secondary battery cell is measured while the battery is loaded. The internal resistance R is calculated by measuring temporal changes in an inter-terminal voltage CCV (closed-circuit voltage) of the secondary battery cell. In other words, the internal resistance R is calculated from temporal changes in the CCV that are caused by a charge/discharge current, which is generated when the load status of the battery changes during a vehicle drive (refer, for instance, to Patent Document 1).

As the internal resistance varies with temperature, it is necessary to accurately measure the temperature of the secondary battery cell and correct the internal resistance. When a load is connected to the battery to permit a current to flow, the temperature in the secondary battery cell rises due to loss in the internal resistance of the secondary battery cell. Therefore, a difference arises between an ambient temperature measured by a temperature sensor disposed external to the secondary battery cell and the temperature in the secondary battery cell. In order to avoid the detection of a temperature different from an actual temperature in the secondary battery cell, Patent Documents 2 and 3 disclosed a technology for detecting the internal resistance of a battery when a vehicle starts up after a prolonged period of inactivity. The reason is that the battery's internal temperature is equal to the battery's ambient temperature when the vehicle has been inactive for a prolonged period of time.

Further, in order to impose a load on the battery of a hybrid electric vehicle (HEV), Patent Documents 2 and 3 also disclosed a technology for driving a motor-generator that is idling with a clutch disengaged.

### PRIOR ART LITERATURE

### Patent Documents

Patent Document 1: JP-2008-256673-A
Patent Document 2: JP-2009-038896-A
Patent Document 3: JP-2009-038898-A

### SUMMARY OF THE INVENTION

### Problems to be Solved by the Invention

However, the motor-generator cannot idle in a hybrid electric vehicle (HEV) or an electric vehicle (EV) in which the motor-generator is directly coupled to a drive shaft of the vehicle. Therefore, when the motor-generator is to be used as a load on the battery, the vehicle is actually driven to determine the internal resistance of the battery. In this instance, as the vehicle is actually electromotively driven, the amount of electrical power consumed by the battery increases. In addition, the vehicle needs to be driven before determining the degradation of the battery from changes in the internal resistance R of the secondary battery cell.

According to a first aspect of the present invention, there is provided a vehicle drive device including: an electric motor that directly drives a vehicle; a first electrical storage device that is of a high-voltage type and includes a plurality of secondary battery cells; an electrical storage control device that monitors a charge/discharge status of the first electrical storage device; a DC-to-AC power conversion device that converts DC power supplied from the first electrical storage device to AC power, and supplies the AC power to the electric motor; a plurality of auxiliary machines mounted in the vehicle; a second electrical storage device that is of a low-voltage type and supplies DC power in order to drive the plurality of auxiliary machines; a DC-to-DC power conversion device that converts DC power from the first electrical storage device, and supplies the converted DC power to the second electrical storage device; and a vehicle control device that provides overall control of the vehicle. The vehicle control device includes a degradation determination section that determines whether a degree of degradation of the first electrical storage device can be determined, an auxiliary machine selection section that selects one or more auxiliary machines from the plurality of auxiliary machines, and a degradation estimation section that drives the one or more auxiliary machines selected by the auxiliary selection section to estimate the degree of degradation of the first electrical storage device when the degradation determination section determines that the degree of degradation of the first electrical storage device can be determined.

According to a second aspect of the present invention, in the vehicle drive device according to the first aspect, preferably, the degradation estimation section estimates the degree of degradation of the first electrical storage device based on an internal resistance value calculated from a current and a voltage of DC power supplied from the first electrical storage device when the one or more auxiliary machines selected by the auxiliary machine selection section are driven.

According to a third aspect of the present invention, in the vehicle drive device according to the first or second aspect, it is preferred that the vehicle includes an engine for driving the vehicle and an auxiliary machine necessary for driving the engine, and that the auxiliary machine selection section preferentially selects the auxiliary machine necessary for driving the engine.

According to a fourth aspect of the present invention, in the vehicle drive device according to the first or second aspect, it is preferred that the vehicle includes a transmission and an auxiliary machine necessary for driving the transmission, and that the auxiliary machine selection section preferentially selects the auxiliary machine necessary for driving the transmission.

According to a fifth aspect of the present invention, in the vehicle drive device according to the first or second aspect, it is preferred that the plurality of auxiliary machines include a vehicle-mounted auxiliary machine operable by a driver of the vehicle, and that the auxiliary machine selection section preferentially selects the auxiliary machine operable by the driver of the vehicle.

According to a sixth aspect of the present invention, in the vehicle drive device according to the first or second aspect, it is preferred that the plurality of auxiliary machines include an auxiliary machine necessary for steering the electric vehicle, and that the auxiliary machine selection section preferentially selects the auxiliary machine necessary for steering the vehicle.

According to a seventh aspect of the present invention, in the vehicle drive device according to the first or second aspect, it is preferred that the plurality of auxiliary machines include an auxiliary machine necessary for braking the electric vehicle, and that the auxiliary machine selection section preferentially selects the auxiliary machine necessary for braking the vehicle.

According to an eighth aspect of the present invention, in the vehicle drive device according to the first or second aspect, it is preferred that the vehicle includes an auxiliary machine that acts as a heat source for the electric vehicle, and that the auxiliary machine selection section preferentially selects the auxiliary machine that acts as a heat source for the vehicle.

According to a ninth aspect of the present invention, in the vehicle drive device according to the third aspect, preferably, when a selection is made to stop the engine and drive the vehicle with the electric motor alone, the degradation determination section prohibits the degradation estimation section from performing a process.

According to a tenth aspect of the present invention, in the vehicle drive device according to the first or second aspect, preferably, when an amount of electrical power stored in the first electrical storage device is smaller than a predetermined value, the degradation determination section prohibits the degradation estimation section from performing a process.

According to an eleventh aspect of the present invention, in the vehicle drive device according to the first or second aspect, preferably, when an amount of electrical power stored in the first electrical storage device is greater than a predetermined value and an amount of electrical power stored in the second electrical storage device is smaller than a predetermined value, the degradation determination section is able to preferentially select an auxiliary machine that is driven at a low voltage by the second electrical storage device.

According to a twelfth aspect of the present invention, in the vehicle drive device according to the first or second aspect, preferably, when an amount of electrical power stored in the first electrical storage device and an amount of electrical power stored in the second electrical storage device are greater than a predetermined value, the degradation determination section is able to preferentially select an auxiliary machine that is driven at a high voltage by the first electrical storage device.

### Advantageous Effect of the Invention

The vehicle drive device according to the present invention makes it possible to determine the degradation of the battery before actually driving the vehicle, and effectively use the electrical power of the battery and determine the degradation of the battery by using a load that consumes a relatively small amount of electrical power and is necessary for making preparations for vehicle drive.

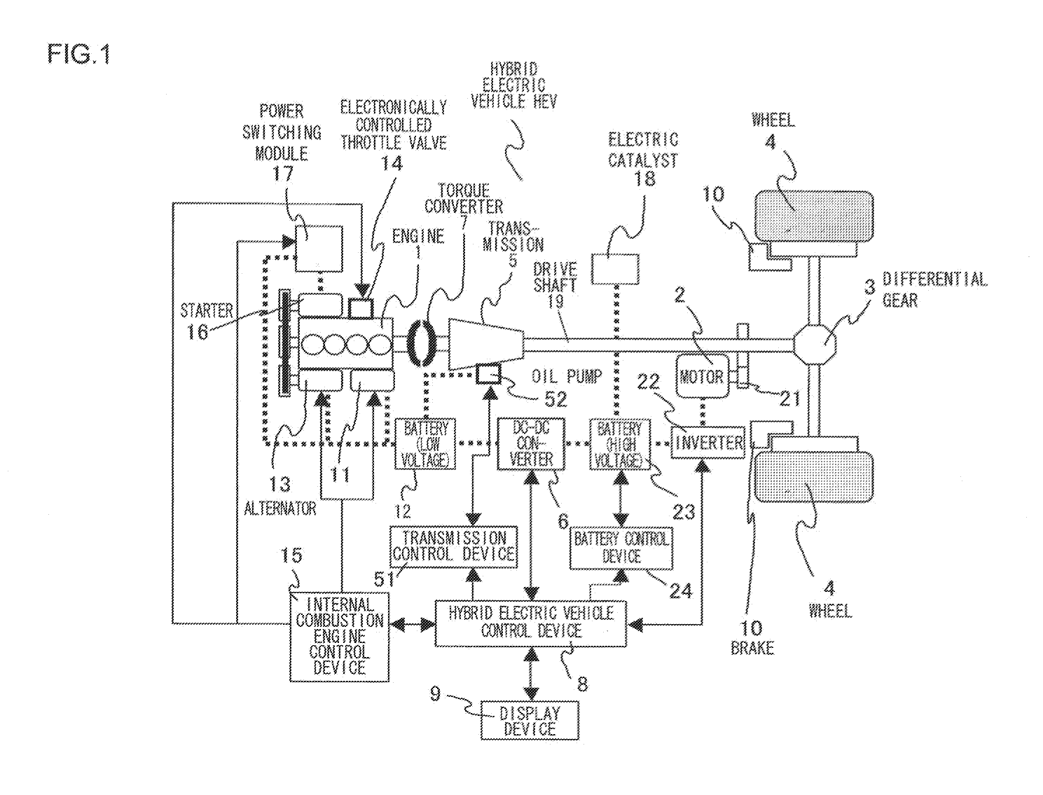

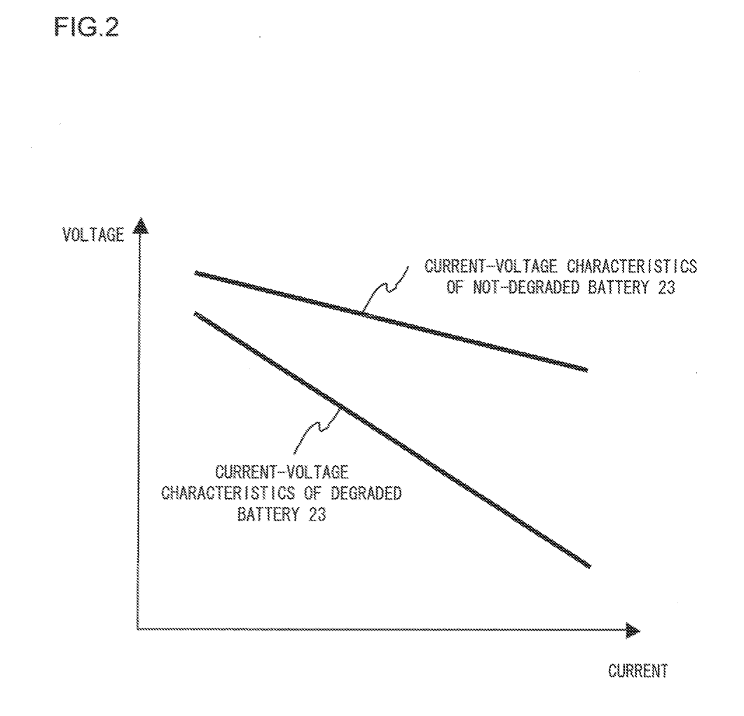

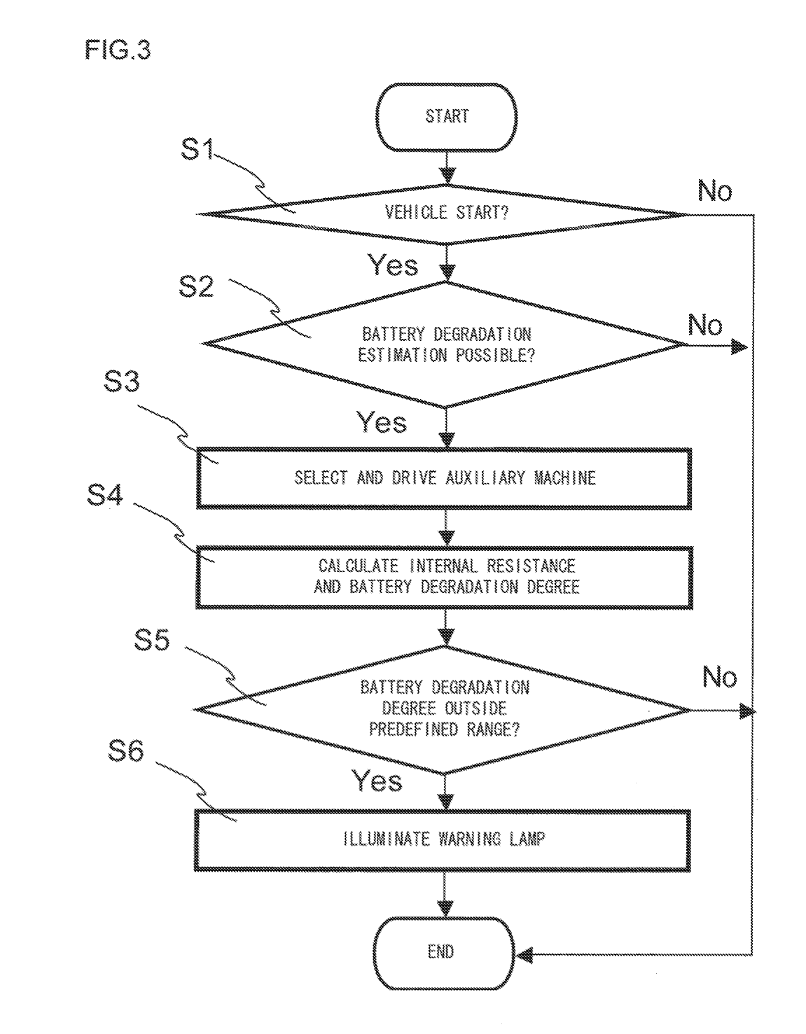

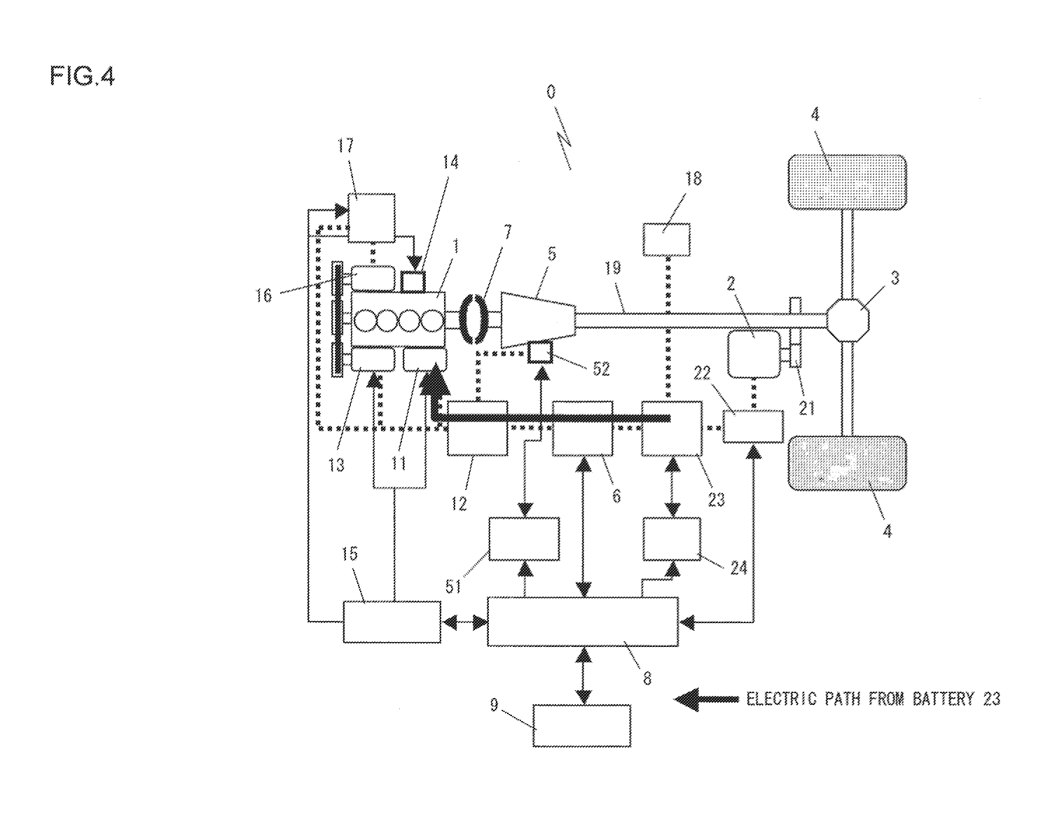

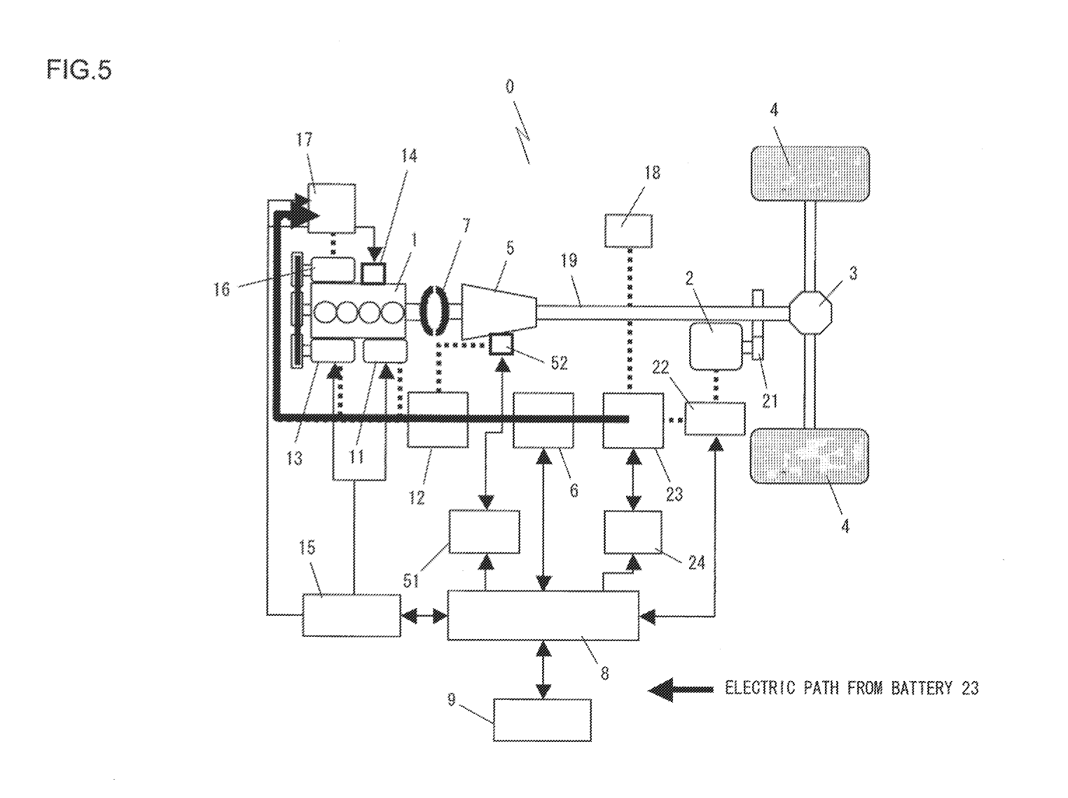

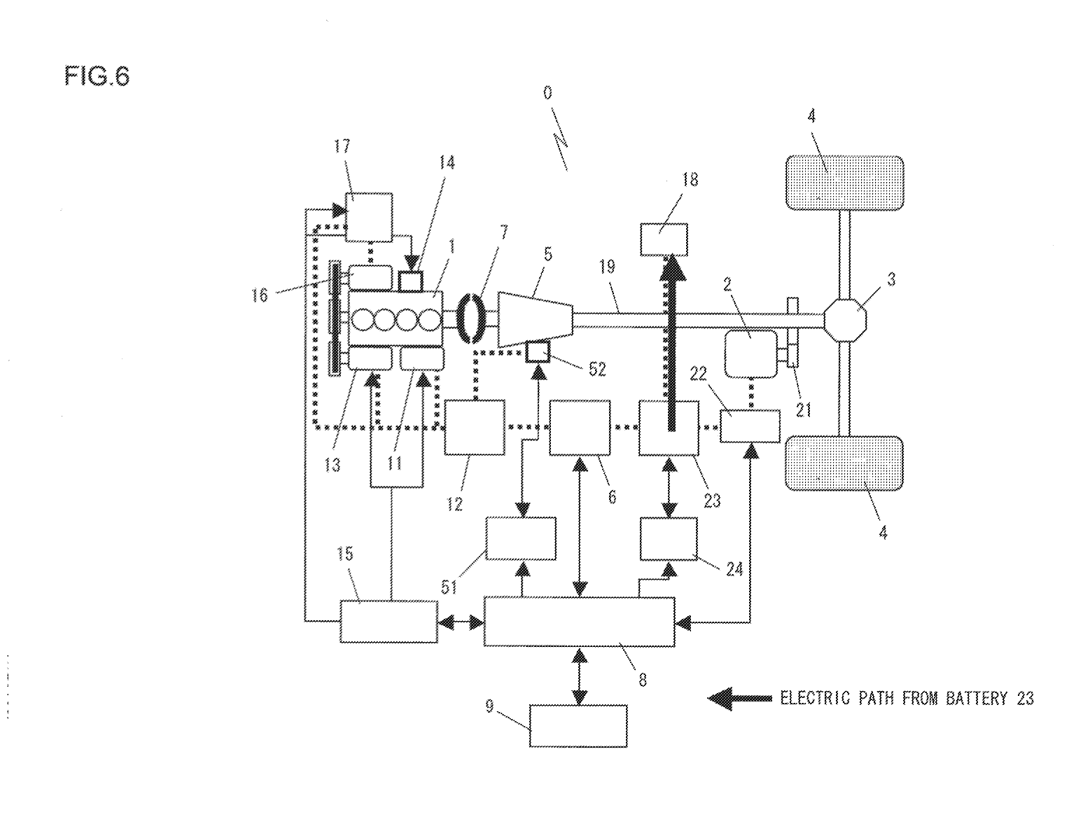

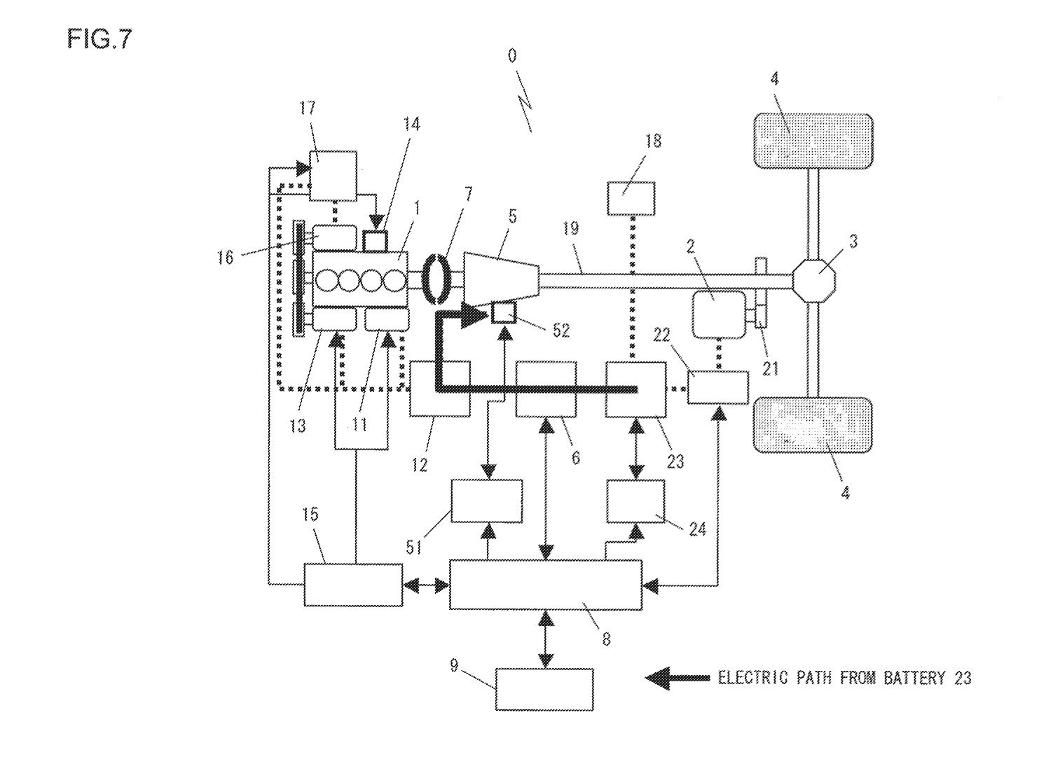

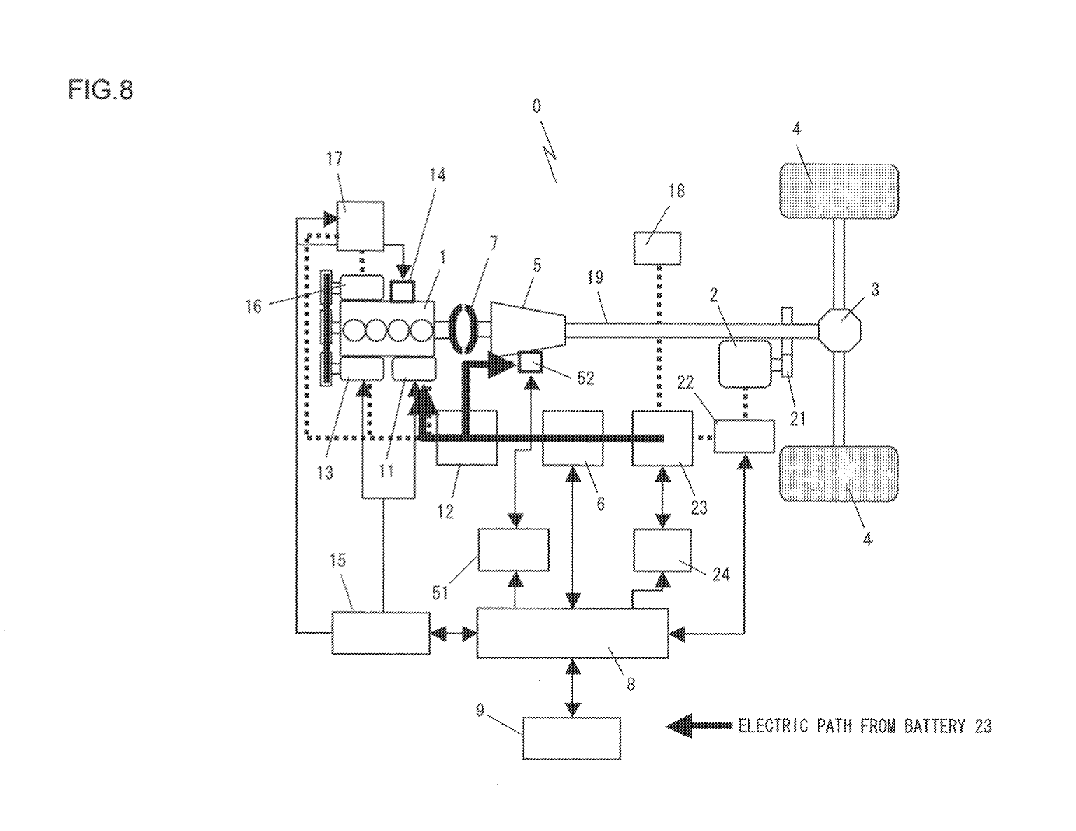

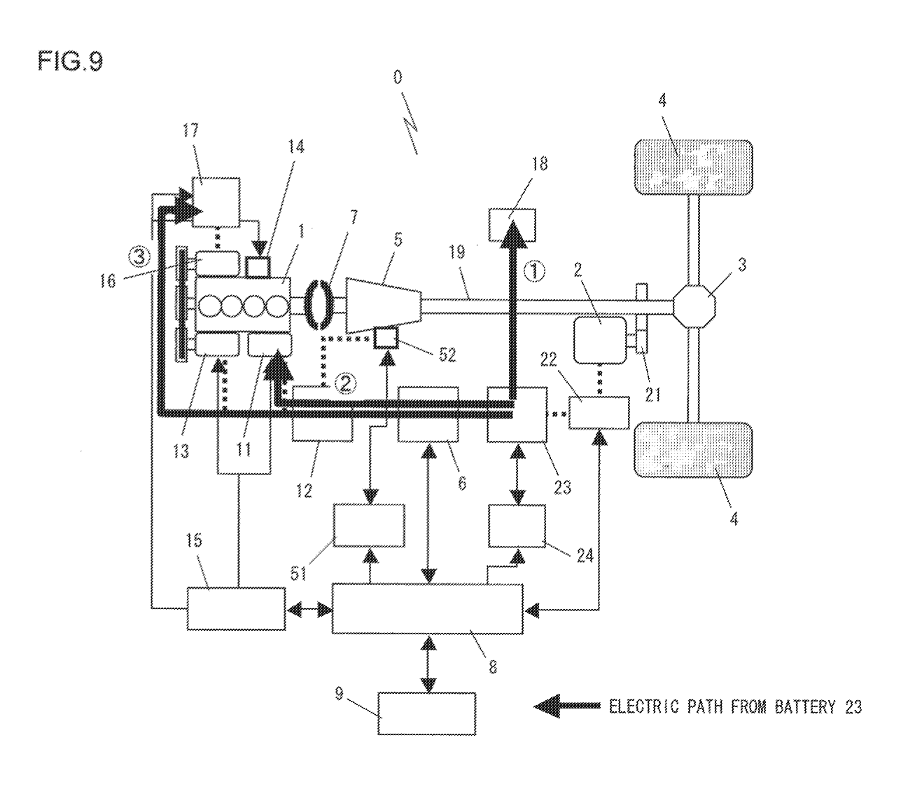

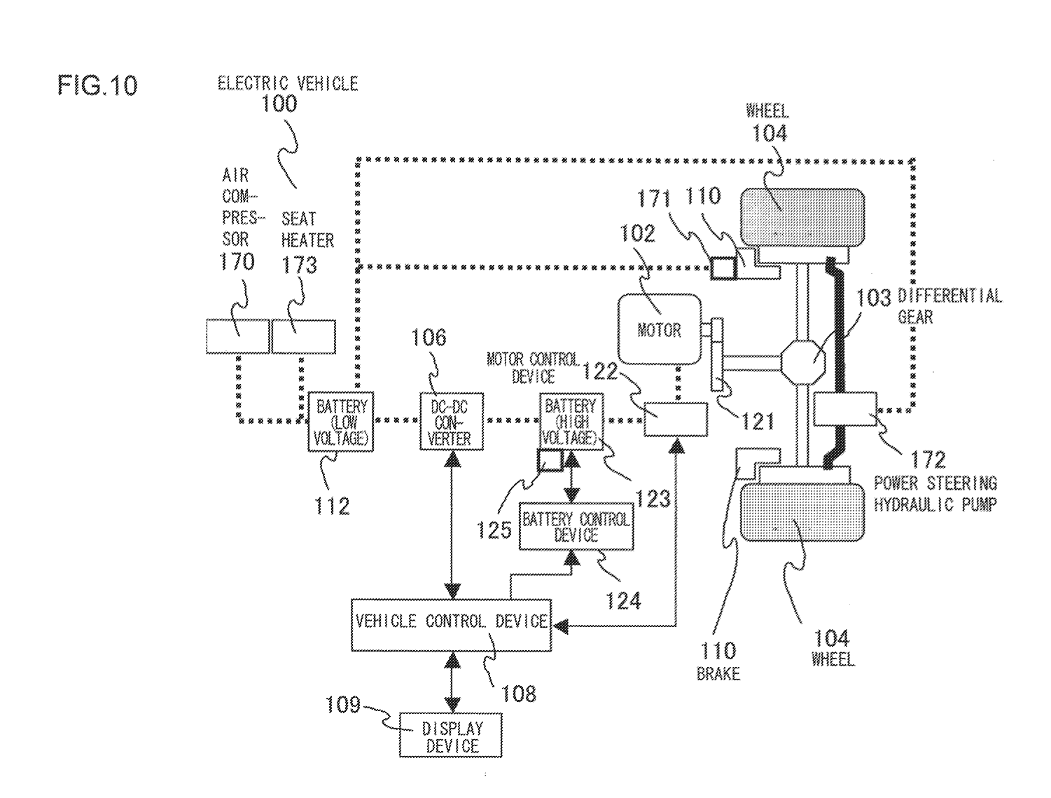

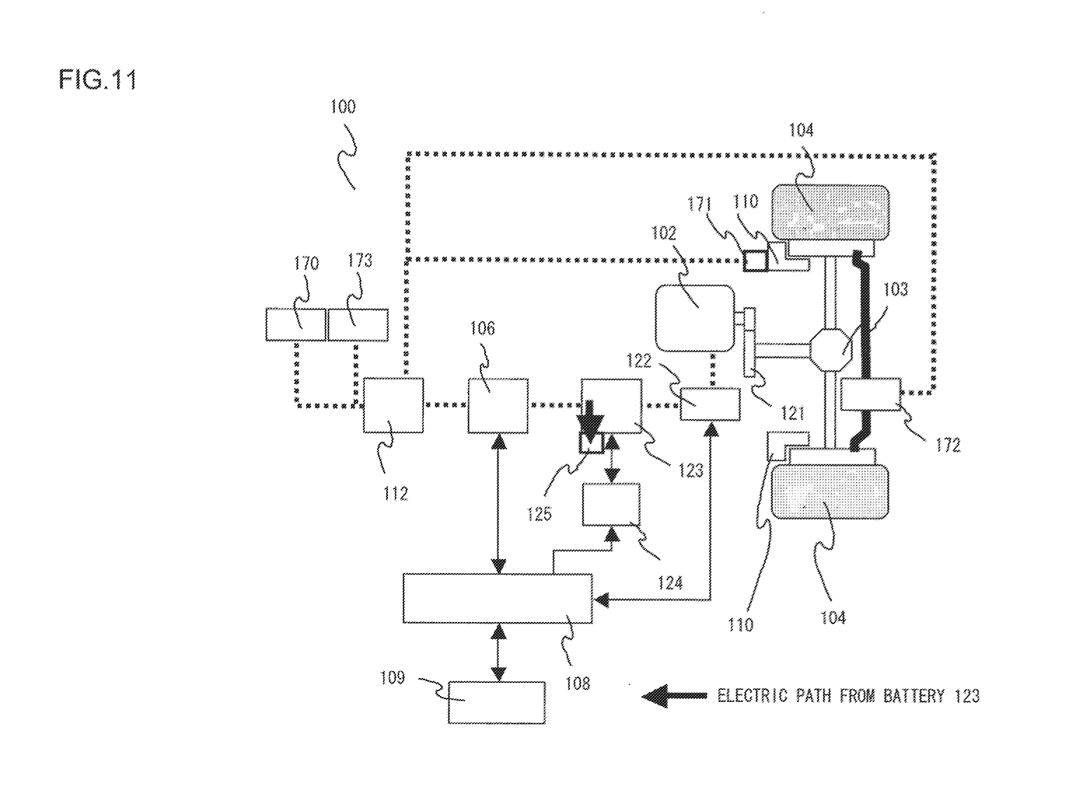

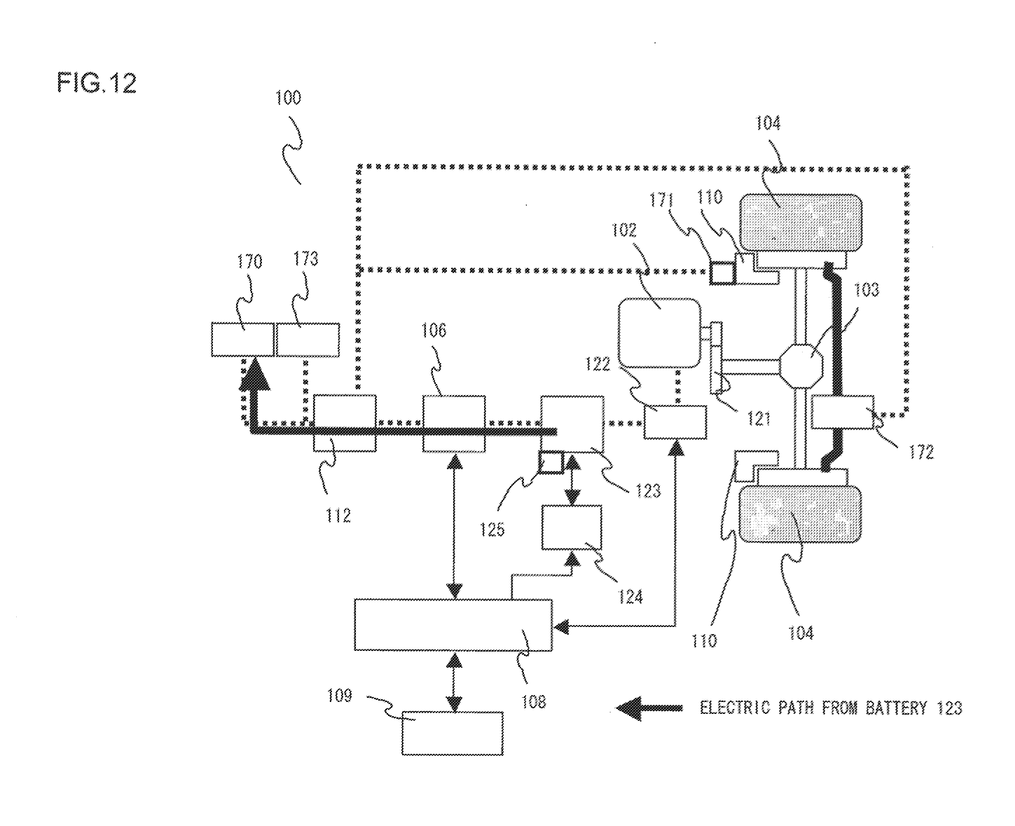

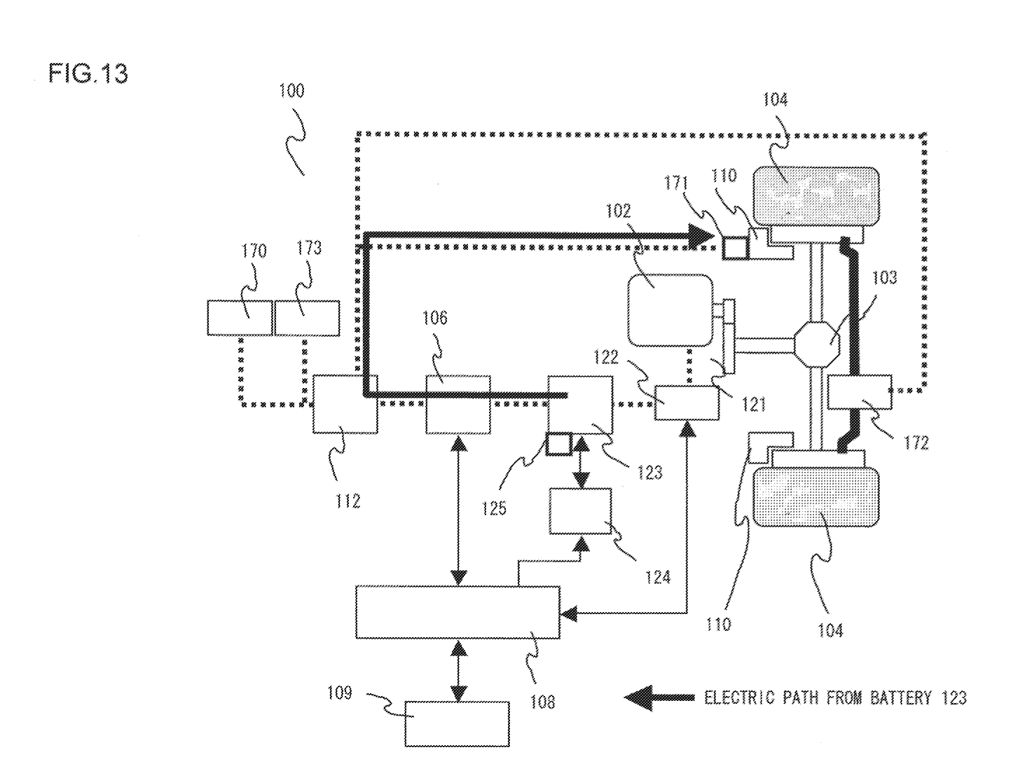

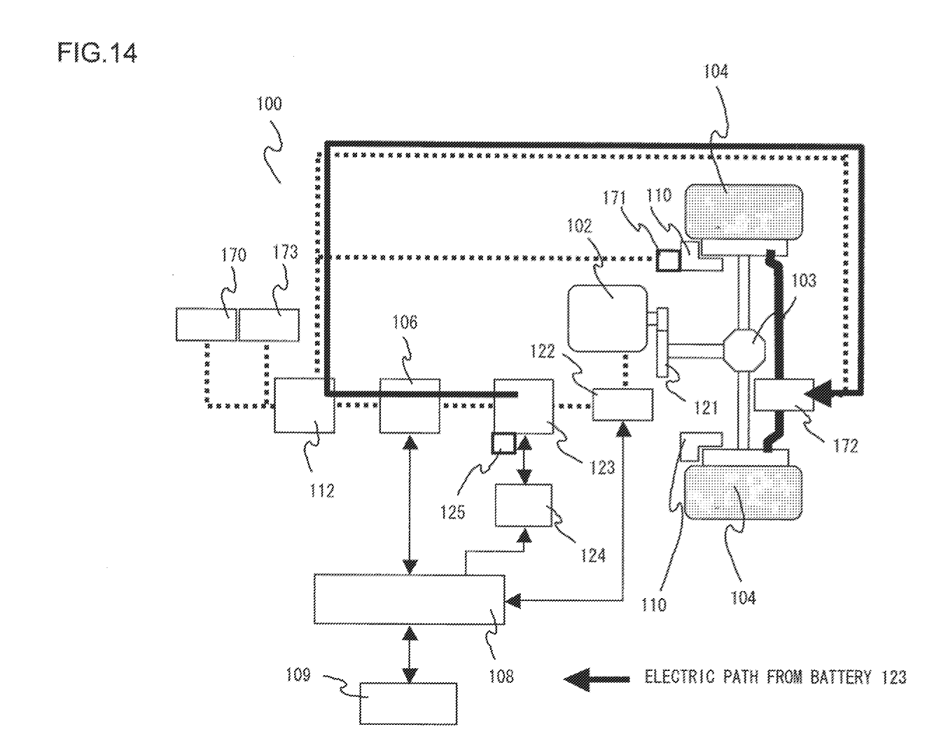

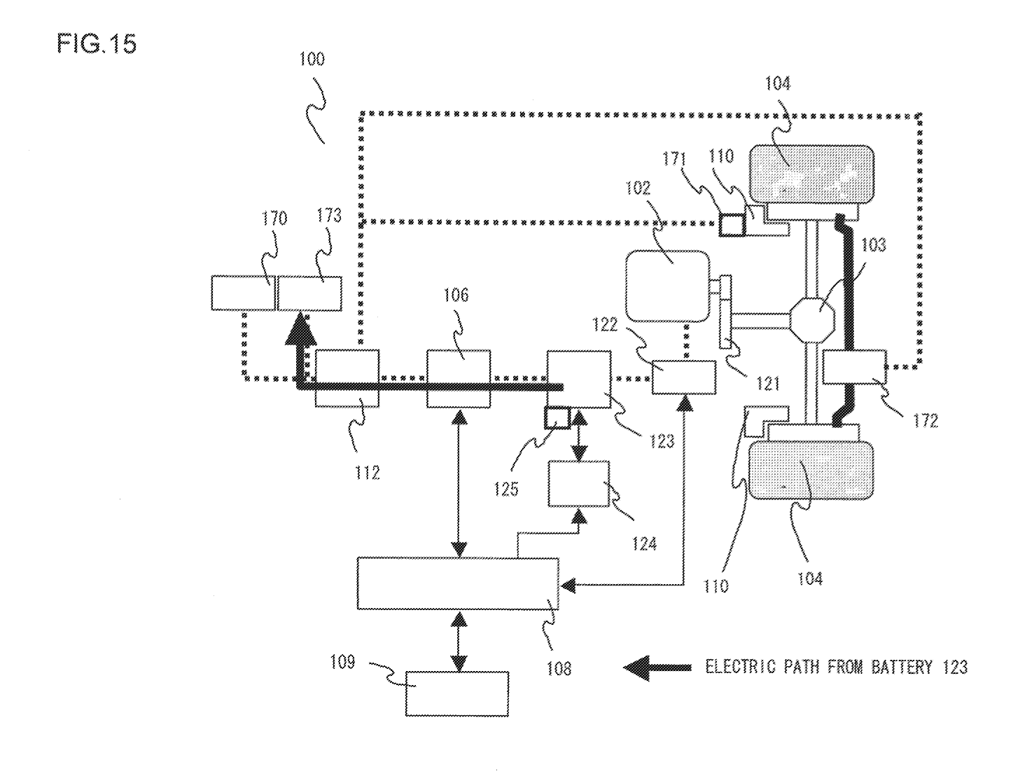

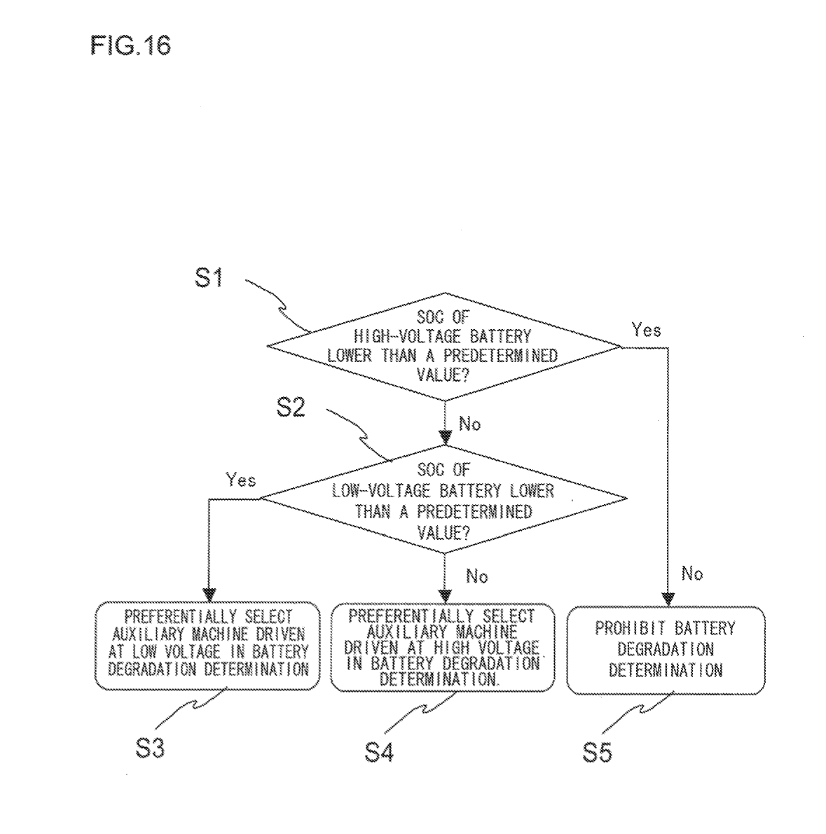

### BRIEF DESCRIPTION OF DRAWINGS

[FIG. 1] FIG. 1 is a schematic diagram illustrating an exemplary overall configuration of a vehicle having a vehicle drive device according to a first embodiment of the present invention.

[FIG. 2] FIG. 2 is a schematic diagram illustrating current-voltage characteristics dependent on the degradation of a common secondary battery cell.

[FIG. 3] FIG. 3 is a flowchart illustrating processing steps performed by a battery degradation estimation function incorporated in the vehicle drive device according to the present invention.

[FIG. 4] FIG. 4 shows a path through which DC power output from a battery 23 is supplied when an engine-driving fuel pump 13 is driven in the first embodiment to estimate the degradation of the battery.

[FIG. 5] FIG. 5 shows a path through which the DC power output from the battery 23 is supplied when a power switching module 17 and a starter 16 are driven in the first embodiment to estimate the degradation of the battery.

[FIG. 6] FIG. 6 shows a path through which the DC power output from the battery 23 is supplied when an electric catalyst 18 is driven in the first embodiment to estimate the degradation of the battery.

[FIG. 7] FIG. 7 shows a path through which the DC power output from the battery 23 is supplied when an oil pump 52 is driven in the first embodiment to estimate the degradation of the battery.

[FIG. 8] FIG. 8 shows a path through which the DC power output from the battery 23 is supplied when the fuel pump 13 and the oil pump 52 are simultaneously driven in the first embodiment to estimate the degradation of the battery.

[FIG. 9] FIG. 9 shows a path through which the DC power output from the battery 23 is supplied when a plurality of auxiliary machines are sequentially started in the first embodiment to estimate the degradation of the battery.

[FIG. 10] FIG. 10 is a schematic diagram illustrating an exemplary overall configuration of a vehicle having the vehicle drive device according to a second embodiment of the present invention. This figure shows an example in which the vehicle drive device according to the present invention is applied to an electric vehicle (EV).

[FIG. 11] FIG. 11 shows a path through which DC power output from a battery 123 is supplied when a battery heater 125 is driven in the second embodiment to estimate the degradation of the battery.

[FIG. 12] FIG. 12 shows a path through which the DC power output from the battery 123 is supplied when an air compressor 170 is driven in the second embodiment to estimate the degradation of the battery.

[FIG. 13] FIG. 13 shows a path through which the DC power output from the battery 123 is supplied when a brake negative pressure pump 171 is driven in the second embodiment to estimate the degradation of the battery.

[FIG. 14] FIG. 14 shows a path through which the DC power output from the battery 123 is supplied when a power steering hydraulic pump 172 is driven in the second embodiment to estimate the degradation of the battery.

[FIG. 15] FIG. 15 shows a path through which the DC power output from the battery 123 is supplied when a seat heater 173 is driven in the second embodiment to estimate the degradation of the battery.

[FIG. 16] FIG. 16 is a flowchart illustrating a process in which an auxiliary machine is selected as a battery load in accordance with the state of charge (SOC) of the battery.

### DESCRIPTION OF EMBODIMENTS

Embodiments of the present invention will now be described with reference to the accompanying drawings.

### First Embodiment

FIG. 1 shows an exemplary overall configuration of a vehicle having a vehicle drive device according to the present invention.

A hybrid electric vehicle HEV uses an internal combustion engine 1 as a first motive power generation device. The engine 1 is connected to an input shaft of a torque converter 7. An output shaft of the torque converter 7 is connected to an input shaft of a transmission 5. An output shaft (drive shaft 19) of the transmission 5 is connected to a differential gear 3. The driving force of the engine 1 is distributed to left and right wheels 4 by the differential gear 3. The wheels 4 are provided with a brake 10, which generates a braking force. An electric motor 2 is used as a second motive power generation device. The electric motor 2 is directly coupled to the drive shaft 19 through a reduction gear 21. The driving force of the electric motor 2 is distributed to the left and right wheels 4 through the differential gear 3. The electric motor 2 is electrically connected to an electric motor control device 22, which controls the electric motor 2. While the electric motor 2 is an AC motor, the electric motor control device 22 is a DC-to-AC converter called an inverter. The electric motor control device 22 receives DC power supplied from a battery 23, which is a DC power source, converts the DC power to AC power, and supplies the AC power to the electric motor 2.

For example, a direct injection engine, which directly injects fuel into a combustion chamber, is used as the engine 1. A high fuel pressure is required for the direct injection engine to inject the fuel. A fuel pump 11 is used to obtain such a high fuel pressure. Electrical power is supplied to drive the fuel pump 11. A battery 12 is used as an electrical power source and electrically connected to the fuel pump 11. Electrical power is supplied to the battery 12 by an alternator 13, which converts the engine's rotary torque to electrical energy.

The engine 1 is provided with an electronically controlled throttle valve 14 so that the output of the engine 1 can be controlled by a request signal from an internal combustion engine control device 15. The engine 1 is started up by a starter 16. The starter 16 is electrically connected to a power switching module 17 that controls the starter 16. The power switching module 17 can control the revolving speed of the starter 16 as it is driven by electrical power supplied from the battery 12. An exhaust gas, which is discharged when the fuel is burned by the engine 1, is passed through an electric catalyst (electrocatalyst) 18 and emitted out of the vehicle. When the exhaust gas passes through the electric catalyst 18, the electric catalyst 18 purifies harmful components of the exhaust gas. The electric catalyst 18 is driven by supplied electrical power. The battery 23 is used as an electrical power source and electrically connected to the electric catalyst 18. When the electric catalyst 18 is driven, it is heated to a temperature appropriate for exhaust gas purification.

For example, a stepped automatic transmission, which is generally referred to as an automatic transmission, or a continuously variable transmission (CVT) is used as the transmission 5. A transmission control device 51 can select an arbitrary gear range to amplify the driving torque of the transmission input shaft and transmit the amplified driving torque to the transmission output shaft. Further, the transmission 5 can operate an actuator incorporated in it to shift into a higher or lower gear, thereby changing the rotary torque and revolving speed of the engine. The actuator is controlled by the transmission control device 51. An oil pump 52 supplies hydraulic pressure as need to drive the torque converter 7 and operate the actuator incorporated in the transmission 5. The oil pump 52 is driven by electrical power supplied from the battery 12.

A three-phase AC line is used to connect the electric motor 2 to the electric motor control device 22, which is called an inverter. Arbitrary driving torque can be generated by controlling a semiconductor element in the inverter with the electric motor control device 22. The electric motor 2 is a so-called motor-generator and capable of entering both a power running state and a braking state. In the power running state, the electric motor 2 accelerates its revolving shaft. In the braking state, the electric motor 2 decelerates its revolving shaft. When in the braking state, the electric motor 2 operates as a generator. While the electric motor 2 is in an electrical power generation state, electrical power obtained when extra torque of the engine 1 is converted to a form of electrical power generated by the electric motor and electrical power generated during regenerative braking during which the braking force of the vehicle is converted to a form of electrical power generated by the electric motor are both used to charge the battery 23.

The battery 23 includes a plurality of secondary battery cells, such as lithium-ion battery cells. A thermistor (not shown) is mounted on the surface of the secondary battery cells and capable of detecting the temperature of the secondary battery cells. The output from the thermistor is input to a battery control device 24 so that the temperature of the secondary battery cells is detected. Further, the battery control device 24 calculates the amount of permissible output electrical power that can be charged into or discharged from the battery 23. Even when the amount of electrical power requested by a hybrid vehicle control device 8 is beyond a permissible input/output range of the battery, an electric motor controller (not shown) built in the electric motor control device limits the amount of actually input/output electrical power to the permissible input/output range.

FIG. 2 schematically illustrates current-voltage characteristics dependent on the degradation of a secondary battery cell such as a lithium-ion battery cell. As is obvious from FIG. 2, the output voltage of the secondary battery cell tends to decrease with an increase in the output current of the secondary battery cell. FIG. 2 also indicates that the degree of voltage decrease increases when the secondary battery cell is progressively degraded. The reason is that a voltage drop is caused by the internal resistance of the secondary battery cell.

The voltage drop in the secondary battery cell is determined by a battery current and the internal resistance of the secondary battery cell. However, when the secondary battery cell is progressively degraded, its internal resistance increases so that the degree of voltage drop in the secondary battery cell increases even if the battery's output current remains unchanged. In other words, the degradation of the battery can be defined by calculating the degree of an increase in the internal resistance of the secondary battery cell.

A DC-to-DC converter 6 electrically connects the battery 12 to the battery 23. The battery 12 is a so-called 12-V battery that drives vehicle-mounted auxiliary machines (or accessories) such as the fuel pump 11. On the other hand, the battery 23 is a high-voltage battery that supplies electrical power to the electric motor 2, which acts as a driving source for the vehicle. The DC-to-DC converter 6 provides voltage conversion so that electrical power can be exchanged between these two batteries having different voltage levels. This ensures that if, for instance, the battery 12 cannot supply electrical power to the fuel pump 11 during its drive period due to an insufficient amount of electrical power remaining in the battery 12, the electrical power remaining in the battery 23 can be supplied to the fuel pump 11 through the DC-to-DC converter 6.

Information such as revolving speeds, torque, and accelerator opening (or accelerator position) is input from the control devices, input shaft rotation sensor (not shown), and output shaft rotation sensor (not shown) to the hybrid vehicle control device 8. The hybrid vehicle control device 8 not only controls the torque and revolving speed of the electric motor 2 through the electric motor control device 22, but also controls the output of the engine 1 through the internal combustion engine control device 15 and the electronically controlled throttle valve 14. The hybrid vehicle control device 8 controls to generate the driving force of the vehicle by providing coordinated control between the above-mentioned control of the electric motor 2 and the above-mentioned control of the engine 1. The hybrid vehicle control device 8 can also control the gear position of the transmission through the transmission control device 51 and an actuator (not shown). Further, the hybrid vehicle control device 8 can control the DC-to-DC converter. Moreover, the hybrid vehicle control device 8 can be made integral with another control device, such as the transmission control device 51, the internal combustion engine control device 15, or the electric motor control device 22, by incorporating functions similar to those of the hybrid vehicle control device 8 into such a control device.

The hybrid vehicle control device 8 has a degradation estimation function for estimating the degradation of the battery 23. The degradation estimation function for the battery is implemented by a degradation determination section (not shown) and a degree-of-degradation estimation section (not shown).

The degradation determination section first determines whether or not to let the degree-of-degradation estimation section perform its process at the start of the vehicle. At first, the degradation determination section memorizes the last date and time at which the vehicle shut down. Next, when the vehicle starts up, the degradation determination section compares the date and time of vehicle start-up against the last date and time at which the vehicle shut down. If a predetermined period of time has elapsed since the last date and time at which the vehicle shut down, the degradation determination section permits the degree-of-degradation estimation section to initiate its process. Vehicle start-up and shut-down can be identified by determining whether an ignition switch is turned on or turned off.

The reason why the degradation determination section checks whether a predetermined period of time has elapsed since vehicle shut-down and determines whether or not to let the degree-of-degradation estimation section for the battery perform its process is described below.

The degradation of the battery is estimated by using the internal resistance of the battery 23, which is corrected in accordance with a detected temperature of the thermistor mounted on the surface of the secondary battery cells, and calculating an increase in the internal resistance from an initial state of the battery 23. While the vehicle repeatedly performs a power running/regeneration sequence during its travel, the motor-generator 2 performs a power running/regeneration operation. When the motor-generator 2 is used for driving purposes, the electric motor control device 22 receives DC power from the battery 23, converts the DC power to AC power, and supplies the AC power. When, on the other hand, the motor-generator 2 is generating AC power by performing a regeneration operation, the electric motor control device 22 converts the generated AC power to DC power and charges the battery 23 with the DC power. Thus, the battery 23 is repeatedly charged and discharged. However, heat is generated in the secondary battery cells due to a charge/discharge current and the internal resistance of the secondary battery cells. This raises the internal temperature of the secondary battery cells so that a temperature difference arises between the interior and the surface of the secondary battery cells. If the internal resistance is calculated while such a temperature difference exists, a correction is made in accordance with the ambient temperature of the secondary battery cells, which is lower than the actual temperature of the secondary battery cells. Hence, the accuracy of internal resistance calculation decreases so that the degree of degradation of the secondary battery cells or of the battery is not correctly determined. As such being the case, it is preferred that the inter-terminal voltage of the secondary battery cells be measured to estimate the degradation of the battery in a situation where the surface temperature of the secondary battery cells and the temperature in the secondary battery cells can be considered equal, that is, after a predetermined period of time (e.g., an overnight period) has elapsed since vehicle shut-down.

When the initiation of a degree-of-degradation estimation process for the battery is permitted, the fuel pump 13, which is an auxiliary machine necessary for driving the vehicle, is driven. In this instance, the DC-to-DC converter is activated to supply the electrical power remaining in the battery 23 to a selected auxiliary machine.

The process performed by the degradation determination section is as described above. After the process is performed by the degradation determination section, the degree-of-degradation estimation section performs its process.

The degree-of-degradation estimation section acquires a battery voltage and current from the battery control device 24, which monitors the battery 23. In accordance with the amounts of changes in the battery voltage and current, which are indicated by the acquired voltage and current, the degree-of-degradation estimation section calculates a measured internal resistance value R of the battery 23. Next, in accordance with the thermistor temperature T of the battery 23 and the state of charge (SOC) of the battery 23, which are acquired from the battery control device 24, the degree-of-degradation estimation section searches a prepared internal resistance map for a reference internal resistance value R_{S} (SOC, T). In accordance with the calculated measured internal resistance value R and with the reference internal resistance value R_{S} (SOC, T), the degree-of-degradation estimation section calculates the degradation of the battery SOH[%] from Equation (1) below:

SOH[%]=R/R_{S}(SOC,T)×100 (1)

The process performed by the degree-of-degradation estimation section is as described above.

If the degradation of the battery SOH calculated as described above is beyond a predefined range, an illumination signal for a battery degradation warning lamp is output to a display device 9.

FIG. 3 illustrates in detail the process performed by the degradation estimation function. At first, in step S1, the degradation estimation function checks whether the ignition switch is moved from the OFF position to the ON position in order to determine whether the vehicle is started up. Next, in step S2, the degradation estimation function determines whether the degradation of the battery can be estimated. More specifically, the degradation estimation function checks whether a predetermined period of time has elapsed between the instant at which the vehicle shut down and the instant at which the ignition switch was turned back ON. If the degradation of the battery cannot be estimated, the degradation estimation function terminates its process. If, on the other hand, the degradation of the battery can be estimated, the degradation estimation function proceeds to step S3 and drives an auxiliary machine. The auxiliary machine to be driven is selected by an auxiliary machine selection section (not shown) included in the hybrid vehicle drive device 8. After the battery is energized, in step S4, the degradation estimation function calculates the internal resistance of each secondary battery cell and the degree of degradation of each secondary battery cell, and determines the degree of degradation of the battery by determining the degree of degradation of the most seriously degraded secondary battery cell. Next, in step S5, the degradation estimation function determines whether the calculated degree of battery degradation is within the predefined range. If the degree of battery degradation is within the predefined range, the degradation estimation function terminates its process. If, on the other hand, the degree of battery degradation is beyond the predefined range, the degradation estimation function proceeds to step S6 and illuminates the warning lamp to notify a driver of the vehicle that the battery is degraded.

In accordance with the status of the vehicle and with an operation performed by the vehicle's driver, the auxiliary machine selection section included in the hybrid vehicle drive device 8 selects the auxiliary machine to be driven in order to estimate the degradation of the battery.

In the above-described embodiment, for example, the current from the battery 23 is supplied to the engine-driving fuel pump 13 through the DC-to-DC converter as shown in FIG. 4 for the purpose of estimating the degradation of the battery. When the engine 1 is a direct injection engine that directly injects the fuel into the combustion chamber, it is necessary to acquire a high fuel pressure for fuel injection. When the fuel pump is driven at vehicle start-up to raise the fuel pressure before engine start-up, it is possible to achieve a good combustion immediately after engine start-up. As the degradation of the battery is estimated simultaneously with such a combustion, battery power can be used more effectively.

In the above instance, therefore, the auxiliary machine selection section preferentially drives the engine-driving fuel pump 13 to ensure that a battery voltage and current are output from the battery 23 as needed for the processing in the degradation determination section.

In the above-described embodiment, the auxiliary machine selection section preferentially selects and drives the fuel pump 13 as an auxiliary machine that acts as a load on the battery 23. However, a different auxiliary machine may be preferentially selected as far as it is required for driving the vehicle. In the configuration of the hybrid electric vehicle HEV, for example, the starter 16, the power switching module 17, and the electric catalyst 18 may be used in addition to the fuel pump 13 as auxiliary machines required for driving the engine. The oil pump 52 may be used as an auxiliary machine required for driving the transmission.

FIG. 5 shows a path through which electrical power is supplied when the power switching module 17 and the starter 16 are selected as battery loads during a battery degradation determination process. The electrical power supplied from the battery 23 is forwarded to the power switching module 17 through the DC-to-DC converter 6 to drive the starter 16. As described above, when the power switching module 17 and the starter 16 are preferentially selected as battery loads, the electrical power required for engine start-up can be used to determine the degradation of the battery. This results in efficient use of battery power.

FIG. 6 shows a path through which electrical power is supplied when the auxiliary machine selection section selects the electric catalyst 18 as a battery load during the battery degradation determination process. The electrical power supplied from the battery 23 is directly forwarded to the electric catalyst 18. As the electric catalyst 18 can be driven at vehicle start-up, the catalyst can be heated to a temperature appropriate for exhaust gas purification. This makes it possible to successfully purify the exhaust gas immediately after engine start-up and at the same time determine the degradation of the battery.

The hybrid electric vehicle HEV has an HEV running mode and an EV running mode. In the HEV running mode, the engine 1 and the electric motor 2 coordinate with each other. In the EV running mode, only the electric motor 2 is driven with the engine 1 brought to a stop. Either of these running modes can be selected by the hybrid vehicle control device 8. If, for instance, the amount of electrical power remaining in the battery is more than adequate when the vehicle is about to start running, the hybrid vehicle control device 8 selects the EV running mode. If, on the contrary, the amount of electrical power remaining in the battery is small, the hybrid vehicle control device 8 selects the HEV running mode. In general, the engine exhibits a low combustion efficiency in a low revolving speed and low torque region that prevails when, for instance, the vehicle starts running. From the viewpoint of the efficiency of vehicle drive, therefore, the EV running mode in which only the motor is used to drive the vehicle should be selected.

As described above, from the viewpoint of the efficiency of vehicle drive, when the hybrid vehicle control device 8 selects the EV running mode before the vehicle starts running, the auxiliary machine selection section may be prohibited from selecting the fuel pump 13, the starter 16, and the power switching module 17 as an auxiliary machine that acts as a battery load.

FIG. 7 shows a path through which electrical power is supplied when the auxiliary machine selection section selects the oil pump 52 as a battery load during the battery degradation determination process. The electrical power supplied from the battery 23 is forwarded to the oil pump 52 through the DC-to-DC converter 6. As the oil pump 52 is started at vehicle start-up, the hydraulic pressure for the torque converter and transmission is obtained so that the output of the engine 1 can be successfully transmitted to the wheels 4. This makes it possible to provide adequate response to an accelerator operation performed by the driver of the vehicle and at the same time determine the degradation of the battery.

When the auxiliary machine selection section makes the above-described auxiliary machine selection to connect a load to the battery 23, the degree of degradation of the battery 23 can be estimated while improving the performance of the vehicle. As a result, the battery power can be used more effectively.

In the above-described embodiment, one of the auxiliary machines mounted in the vehicle is selected to impose a load on the battery. However, the auxiliary machine selection section may preferentially select and simultaneously drive a plurality of auxiliary machines, such as the fuel pump 13 and the oil pump 52, as shown in FIG. 8. When the internal resistance of the secondary battery cells is to be measured, it is necessary to allow a current having a value greater than a specified value to flow for the purpose of increasing the accuracy of measurement. Hence, when a certain auxiliary machine is driven alone, a desired current cannot be flowed. In such an instance, when a plurality of auxiliary machines are simultaneously driven, a desired current can be flowed.

Further, the above-mentioned auxiliary machines may be sequentially selected and driven by the auxiliary machine selection section. For example, as shown in FIG. 9, the auxiliary machines to be sequentially driven may be selected by driving the electric catalyst 18 after vehicle start-up, then driving the fuel pump 11 after the lapse of a predetermined period of time, and then driving the power switching module 17 after the lapse of a predetermined period of time to start the engine 1.

### Second Embodiment

The present invention is not limited to the above-described embodiment. A second embodiment of the present invention will now be described. FIG. 10 shows another exemplary overall configuration of the vehicle having an electric vehicle drive device according to the present invention.

An electric vehicle 100 uses an electric motor 102 as a motive power generation device. The electric motor 2 is connected to wheels 104 through a reduction gear 121 and a differential gear 103. The wheels 104 are connected to a brake 110, which can generate a braking force. The electric motor 102 is electrically connected to an electric motor control device 122 that controls the electric motor 102. The electric motor control device 122 is a DC-to-AC conversion device called an inverter. A battery 123 is mounted as a power source for the electric motor control device 122. A battery 112 is a so-called 12-V battery that drives vehicle-mounted auxiliary machines. A DC-to-DC converter 106 electrically connects the battery 112 to the battery 123. Further, an air compressor 170 for interior air conditioning and a seat heater 173 are mounted and can be activated and driven by the driver of the vehicle.

The brake 110 is provided with a brake negative pressure pump 171. The brake negative pressure pump 171 doubles a brake pedal force that is generated when the driver of the vehicle steps on a brake pedal, and converts the brake pedal force to a vehicle braking force. The brake negative pressure pump 171 is an electrically driven pump that is driven when electrical power is supplied from the battery 112 or supplied from the battery 123 through the DC-to-DC converter 106.

The wheels 104 are connected to a steering device that steers the vehicle when the driver manipulates a steering wheel. The steering device is connected to a power steering hydraulic pump 172. The power steering hydraulic pump 172 is an electrically driven pump that is driven when electrical power is supplied from the battery 112 or supplied from the battery 123 through the DC-to-DC converter 106.

The battery 123 is configured so that a thermistor is mounted on the surface of secondary battery cells. Therefore, the temperature of the battery 123 can be detected. The temperature of the thermistor is detected by a battery control device 124. The battery control device 124 controls the charge/discharge amount of electrical power. Even if an electrical power request issued by the electric motor control device 122 is beyond the permissible input/output range, the battery control device 124 controls the actual input/output of electrical power. The battery 123 is connected to a battery heater 125. The battery heater 125 is driven by electrical power supplied from the battery 123.

Information such as torque, revolving speeds, and accelerator opening (or accelerator position) is input from the control devices to a vehicle drive device 108. The vehicle drive device 108 determines a vehicle drive torque in accordance with the input information and issues a torque command to the electric motor control device 122. The vehicle drive device 108 directly issues a drive command to various auxiliary machines or indirectly issues a drive command to the various auxiliary machines through the control devices. The vehicle drive device 108 can control the DC-to-DC converter 106 in such a manner that electrical power charged in the batteries 112, 123 is exchanged between the batteries 112, 123 in accordance with the amount of electrical power charged in the batteries 112, 123.

In the electric vehicle 100 configured as described above, too, the vehicle control device 108 can perform the battery degradation determination process shown in FIG. 2. However, the hybrid electric vehicle HEV and the electric vehicle 100 differ in the auxiliary machines mounted in the vehicle. Therefore, the hybrid electric vehicle HEV and the electric vehicle 100 differ in the auxiliary machines that are selectable by the auxiliary machine selection section during the battery degradation determination process shown in FIG. 2.

In the configuration shown for the electric vehicle 100, the selectable auxiliary machines are, for example, the battery heater 125, the air compressor 170, the brake negative pressure pump 171, the power steering hydraulic pump 172, and the seat heater 173.

FIG. 11 shows a path through which electrical power is supplied when the auxiliary machine selection section selects the battery heater 125 as an auxiliary machine that acts as a battery load during the battery degradation determination process. Electrical power is directly supplied from the battery 123 to the battery heater 125 to raise the temperature of the battery 123. In general, the internal resistance of a battery is higher at a low temperature (e.g., 0° C.) than at an ordinary temperature (e.g., 20° C.). Therefore, the electrical power that can be output from the battery decreases with a decrease in its temperature. Hence, if the temperature of the battery is low at vehicle start-up, it is preferred that the battery temperature be raised as soon as possible. When, as described above, the auxiliary machine selection section preferentially selects the battery heater 125 as an auxiliary machine acting as a battery load, it is possible to obtain an adequate output performance from the battery 123 and at the same time determine the degradation of the battery.

FIG. 12 shows a path through which electrical power is supplied when the auxiliary machine selection section selects the air compressor 170 as an auxiliary machine that acts as a battery load during the battery degradation determination process. Electrical power supplied from the battery 123 is forwarded through the DC-to-DC converter 106 and used to drive the air compressor 170. The air compressor 170 is selectively driven in accordance with the position of an associated switch, which is to be manipulated by the driver of the vehicle. Therefore, if the switch is turned on by the vehicle's driver before vehicle start-up, the auxiliary machine selection section selects the air compressor 170 as an auxiliary machine acting as a battery load. As the auxiliary machine selection section preferentially selects the air compressor 170 as an auxiliary machine acting as a battery load, it is possible to determine the degradation of the battery and at the same time provide air-conditioning control in a vehicle compartment in compliance with a request of the vehicle's driver.

FIG. 13 shows a path through which electrical power is supplied when the auxiliary machine selection section selects the brake negative pressure pump 171 as an auxiliary machine that acts as a battery load during the battery degradation determination process. Electrical power supplied from the battery 123 is forwarded through the DC-to-DC converter 106 and used to drive the brake negative pressure pump 171. When the brake negative pressure pump 171 is driven, it amplifies the brake pedal force that is generated when the vehicle's driver steps on the brake pedal. The amplified brake pedal force is then used as the vehicle braking force. When, as described above, the auxiliary machine selection section preferentially selects the brake negative pressure pump 171 as an auxiliary machine acting as a battery load, it is possible to determine the degradation of the battery and at the same time provide an adequate braking force.

FIG. 14 shows a path through which electrical power is supplied when the auxiliary machine selection section selects the power steering hydraulic pump 172 as an auxiliary machine that acts as a battery load during the battery degradation determination process. Electrical power supplied from the battery 123 is forwarded through the DC-to-DC converter 106 and used to drive the power steering hydraulic pump 172. When the power steering hydraulic pump is driven, it amplifies a steering force that is generated when the vehicle's driver manipulates the steering wheel. The amplified steering force is then used to steer the vehicle. When, as described above, the auxiliary machine selection section preferentially selects the power steering hydraulic pump 172 as an auxiliary machine acting as a battery load, it is possible to determine the degradation of the battery and at the same time provide an adequate vehicle steering force.

FIG. 15 shows a path through which electrical power is supplied when the seat heater 173 is selected as an auxiliary machine that acts as a battery load during the battery degradation determination process. Electrical power supplied from the battery 123 is forwarded through the DC-to-DC converter 106 and used to drive the seat heater 173. The seat heater 173 is selectively driven in accordance with the position of an associated switch, which is to be manipulated by the vehicle's driver. Therefore, if the switch is turned on by the vehicle's driver before vehicle start-up, the seat heater 173 can be selected as an auxiliary machine acting as a battery load. As the auxiliary machine selection section preferentially selects the seat heater 173 as an auxiliary machine acting as a battery load, it is possible to determine the degradation of the battery and at the same time adjust the temperature of a seat in compliance with a request of the vehicle's driver.

In other words, the auxiliary machine selection section can select the battery heater 125 (see FIG. 11) or the seat heater 173 (see FIG. 15) as an auxiliary machine that acts as a heat source of the vehicle.

FIG. 16 is a flowchart illustrating a process in which an auxiliary machine is selected as a battery load in accordance with the state of charge (SOC) of the battery. In general, an SOC range within which electrical power can be output in a normal manner is defined for a battery. If electrical power is charged into or discharged from the battery beyond such a range, the degradation of the battery may be accelerated. For a high-voltage battery, for example, upper and lower limit SOC values (e.g., 40% to 60%) are defined. If battery power is consumed beyond the lower limit SOC value, the degradation of the battery is accelerated. When a high-voltage battery and a low-voltage battery are provided as described in conjunction with the first and second embodiments, it is preferred that an auxiliary machine selection be made in accordance with the states of charge of such two types of batteries.

First of all, a check is performed in step 51 shown in FIG. 16 to determine whether the SOC of the high-voltage battery is lower than a predetermined value. If the SOC of the high-voltage battery is lower than the predetermined value, processing proceeds to step S5. In step S5, the auxiliary machine selection section is prohibited from selecting any auxiliary machine of the vehicle. Hence, any further battery power consumption is suppressed when the battery SOC is lower than the predetermined value, that is, the amount of electrical power remaining in the battery is small. This makes it possible to prevent the battery from being degraded. If, on the other hand, the SOC of the high-voltage battery is not lower than the predetermined value, processing proceeds to step S2. In step S2, a check is performed to determine whether the SOC of the low-voltage battery is lower than a predetermined value. If the SOC of the low-voltage battery is not higher than the predetermined value, processing proceeds to step S3. In step S3, the auxiliary machine selection section preferentially selects an auxiliary machine that is driven at a low voltage. As described above, if the SOC of the low-voltage battery is not higher than the predetermined value, that is, the amount of electrical power remaining in the battery is small, electrical power is supplied alternatively from the high-voltage battery whose electrical power is more than adequate. This makes it possible to prevent the low-voltage battery from being degraded. If, on the other hand, the result of the check performed in step S3 indicates that the SOC of the low-voltage battery is not lower than the predetermined value, processing proceeds to step S4. In step S4, the auxiliary machine selection section preferentially selects an auxiliary machine that is driven at a high voltage.

As described above, when a sufficient amount of electrical power is stored in the high-voltage battery and in the low-voltage battery, battery power can be effectively used by driving an auxiliary machine that is to be driven at a high voltage without using the DC-to-DC converter. When an auxiliary machine to be driven at a low voltage is driven, electrical power stored in the high-voltage battery is voltage-converted by the DC-to-DC converter and supplied. Hence, an electrical power loss occurs during a process of such voltage conversion. This is not preferable from the viewpoint of effective use of electrical power. When an auxiliary machine for battery loading is selected for the battery degradation determination process in accordance with the SOC of the high-voltage battery and of the low-voltage battery as described above, it is possible to determine the degradation of the battery while avoiding battery degradation and effectively using the electrical power.

As described above, in the electric vehicle 100 configured as described above, too, the degree of degradation of the battery 23 can be estimated while improving the performance of the vehicle as far as the auxiliary machine selection section selects a vehicle's auxiliary machine to impose a load on the battery 23. As a result, the battery power can be used more effectively.

The above description relates to exemplary embodiments of the present invention. The present invention is not limited to such exemplary embodiments. It is to be understood that various changes and modifications may be made by those skilled in the art without departing from the scope of the present invention.

The disclosure of the following priority-based application is incorporated herein by reference:
Japanese Patent Application No. 2011-179025 (filed on Aug. 18, 2011)

1-12. (canceled)

13. A vehicle drive device comprising:
an electric motor that directly drives a vehicle;
a first electrical storage device that is of a high-voltage type and includes a plurality of secondary battery cells;
an electrical storage control device that monitors a charge/discharge status of the first electrical storage device;
a DC-to-AC power conversion device that converts DC power supplied from the first electrical storage device to AC power, and supplies the AC power to the electric motor;
a plurality of auxiliary machines mounted in the vehicle;
a second electrical storage device that is of a low-voltage type and supplies DC power in order to drive the plurality of auxiliary machines;
a DC-to-DC power conversion device that converts DC power from the first electrical storage device, and supplies the converted DC power to the second electrical storage device; and
a vehicle control device that provides overall control of the vehicle, wherein:
the vehicle control device includes
a degradation determination section that determines whether a degree of degradation of the first electrical storage device can be determined,
an auxiliary machine selection section that selects one or more auxiliary machines from the plurality of auxiliary machines, and
a degradation estimation section that drives the one or more auxiliary machines selected by the auxiliary selection section to estimate the degree of degradation of the first electrical storage device when the degradation determination section determines that the degree of degradation of the first electrical storage device can be determined; and
when an amount of electrical power stored in the first electrical storage device is greater than a predetermined value and an amount of electrical power stored in the second electrical storage device is smaller than a predetermined value, the auxiliary machine selection section preferentially selects an auxiliary machine that is operated at a low voltage by the second electrical storage device.

14. The vehicle drive device according to claim 13, wherein:
the degradation estimation section estimates the degree of degradation of the first electrical storage device based on an internal resistance value calculated from a current and a voltage of DC power supplied from the first electrical storage device when the one or more auxiliary machines selected by the auxiliary machine selection section are driven.

15. The vehicle drive device according to claim 13, wherein:
the vehicle includes an engine for driving the vehicle and an auxiliary machine necessary for driving the engine; and
the auxiliary machine selection section preferentially selects the auxiliary machine necessary for driving the engine.

16. The vehicle drive device according to claim 13, wherein:
the vehicle includes a transmission and an auxiliary machine necessary for driving the transmission; and
the auxiliary machine selection section preferentially selects the auxiliary machine necessary for driving the transmission.

17. The vehicle drive device according to claim 13, wherein:
the plurality of auxiliary machines include a vehicle-mounted auxiliary machine operable by a driver of the vehicle; and
the auxiliary machine selection section preferentially selects the auxiliary machine operable by the driver of the vehicle.

18. The vehicle drive device according to claim 13, wherein:
the plurality of auxiliary machines include an auxiliary machine necessary for steering the electric vehicle; and
the auxiliary machine selection section preferentially selects the auxiliary machine necessary for steering the vehicle.

19. The vehicle drive device according to claim 13, wherein:
the plurality of auxiliary machines include an auxiliary machine necessary for braking the electric vehicle; and
the auxiliary machine selection section preferentially selects the auxiliary machine necessary for braking the vehicle.

20. The vehicle drive device according to claim 13, wherein:
the vehicle includes an auxiliary machine that acts as a heat source for the electric vehicle; and
the auxiliary machine selection section preferentially selects the auxiliary machine that acts as a heat source for the vehicle.

21. The vehicle drive device according to claim 15, wherein:
when a predetermined period of time has not elapsed since vehicle shut-down, the degradation determination section determines whether or not to let the degradation estimation section perform a process.

22. The vehicle drive device according to claim 13, wherein:
when an amount of electrical power stored in the first electrical storage device is smaller than a predetermined value, the degradation determination section prohibits the degradation estimation section from performing a process.

23. The vehicle drive device according to claim 13, wherein:
when an amount of electrical power stored in the first electrical storage device and an amount of electrical power stored in the second electrical storage device are greater than a predetermined value, the auxiliary machine selection section is able to preferentially select an auxiliary machine that is driven at a high voltage by the first electrical storage device.

24. A vehicle drive device comprising:
an electric motor that directly drives a vehicle;
a first electrical storage device that is of a high-voltage type and includes a plurality of secondary battery cells;
an electrical storage control device that monitors a charge/discharge status of the first electrical storage device;
a DC-to-AC power conversion device that converts DC power supplied from the first electrical storage device to AC power, and supplies the AC power to the electric motor;
a plurality of auxiliary machines mounted in the vehicle;
a second electrical storage device that is of a low-voltage type and supplies DC power in order to drive the plurality of auxiliary machines;
a DC-to-DC power conversion device that converts DC power from the first electrical storage device, and supplies the converted DC power to the second electrical storage device; and
a vehicle control device that provides overall control of the vehicle, wherein:
the vehicle control device includes a degradation determination section that determines whether a degree of degradation of the first electrical storage device can be determined,
an auxiliary machine selection section that selects one or more auxiliary machines from the plurality of auxiliary machines, and
a degradation estimation section that drives the one or more auxiliary machines selected by the auxiliary selection section to estimate the degree of degradation of the first electrical storage device when the degradation determination section determines that the degree of degradation of the first electrical storage device can be determined; and
when an amount of electrical power stored in the first electrical storage device and an amount of electrical power stored in the second electrical storage device are greater than predetermined values, the auxiliary machine selection section preferentially selects an auxiliary machine that is operated at a high voltage by the first electrical storage device.

25. The vehicle drive device according to claim 13, wherein the degradation estimation section estimates the degree of degradation of the first electrical storage device based on an internal resistance value calculated from a current and a voltage of DC power supplied from the first electrical storage device when the one or more auxiliary machines selected by the auxiliary machine selection section are driven.

26. The vehicle drive device according to claim 13, wherein:
when the vehicle control device chooses to stop the engine and drive the vehicle with the electric motor alone, the vehicle control device prohibits the auxiliary machine selection section from selecting an auxiliary machine necessary for driving the engine.
